(19) United States
(12) Patent Application Publication
(10) Pub. No.: US 2009/0151169 A1
(43) Pub. Date: Jun. 18, 2009

(54) Gardening Shears Having Energy-Saving Function

(76) Inventor: Yao-Chung Huang, Changhua Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/391,544

(22) Filed: Feb. 24, 2009

Related U.S. Application Data
(62) Division of application No. 11/707,780, filed on Feb. 16, 2007.

(51) Int. Cl. B26B 17/02

(52) U.S. Cl. 30/185

(57) ABSTRACT

A pair of gardening shears include two support seats spaced from each other, an anvil mounted between the support seats, a slide movably mounted between the support seats and having a cutting blade that is movable relative to the anvil, and a rotation arm pivotally mounted between the support seats to move the slide relative to the anvil by rotation of the rotation arm relative to the support seats and the slide. The slide has a side formed with an elongated driven rack. The rotation arm has an end portion formed with a drive gear portion pivotally mounted between the support seats and meshing with the driven rack of the slide.

### CROSS-REFERENCES TO RELATED APPLICATIONS

The present invention is a divisional application of the co-pending U.S. Ser. No. 11/707,780, filed on Feb. 16, 2007, now pending.

### BACKGROUND OF THE INVENTION

1. Field of the Invention

The present invention relates to a gardening cutting tool and, more particularly, to a pair of gardening shears for shearing plant.

2. Description of the Related Art

A gardening cutting tool, such as a pair of energy-saving gardening shears, is used to cut or shear a plant, such as the branches of a tree, in an energy-saving manner, thereby facilitating a user operating the gardening cutting tool. However, the conventional gardening cutting tool has a very complicated construction, thereby greatly increasing the costs of fabrication and assembly.

### BRIEF SUMMARY OF THE INVENTION

In accordance with the present invention, there is provided a pair of gardening shears, comprising two support seats spaced from each other, an anvil mounted between the support seats, a slide movably mounted between the support seats and having an end portion formed with a cutting blade that is movable relative to the anvil, and a rotation arm pivotally mounted between the support seats and connected to the slide to move the slide relative to the anvil by rotation of the rotation arm relative to the support seats and the slide. The slide has a side formed with an elongated driven rack. The rotation arm has an end portion formed with a drive gear portion pivotally mounted between the support seats and meshing with the driven rack of the slide.

The primary objective of the present invention is to provide a pair of gardening shears having an energy-saving function.

Another objective of the present invention is to provide a pair of gardening shears, wherein the gardening shears comprise two support seats, an anvil, a slide, a rotation arm, and a restoring spring so that the gardening shears have a simplified construction, thereby decreasing the costs of fabrication and assembly.

A further objective of the present invention is to provide a pair of gardening shears, wherein the drive handle of the rotation arm drives the drive gear portion of the rotation arm by a leverage action to move the driven rack of the slide, so that the rotation arm produces a two-stage drive force on the slide to drive the cutting blade of the slide to move toward the anvil in an energy-saving manner, thereby greatly facilitating a user operating the gardening shears.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pair of gardening shears in accordance with the preferred embodiment of the present invention.

FIG. 2 is an exploded perspective view of the gardening shears as shown in FIG. 1.

FIG. 3 is a partially side view of the gardening shears as shown in FIG. 1.

FIG. 4 is a schematic operational view of the gardening shears as shown in FIG. 1.

FIG. 5 is a schematic operational view of the gardening shears as shown in FIG. 4.

FIG. 6 is a side view of the gardening shears as shown in FIG. 5.

FIG. 7 is a perspective view of a pair of gardening shears in accordance with another preferred embodiment of the present invention.

### DETAILED DESCRIPTION OF THE INVENTION

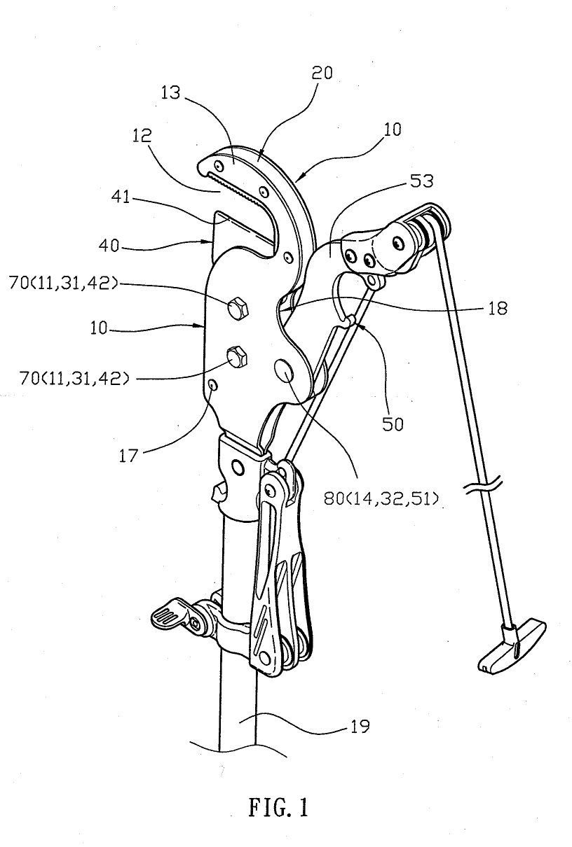

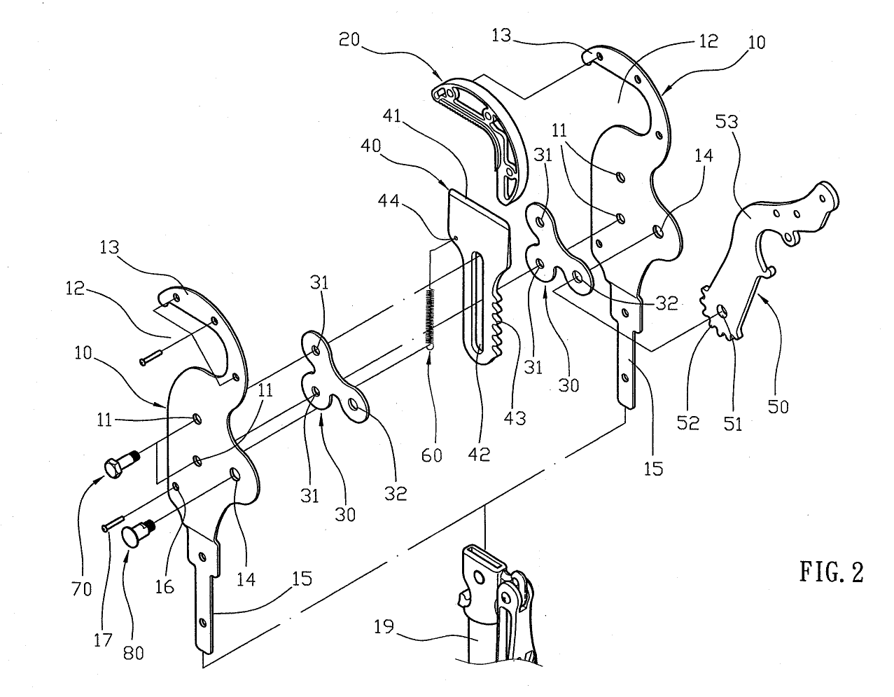

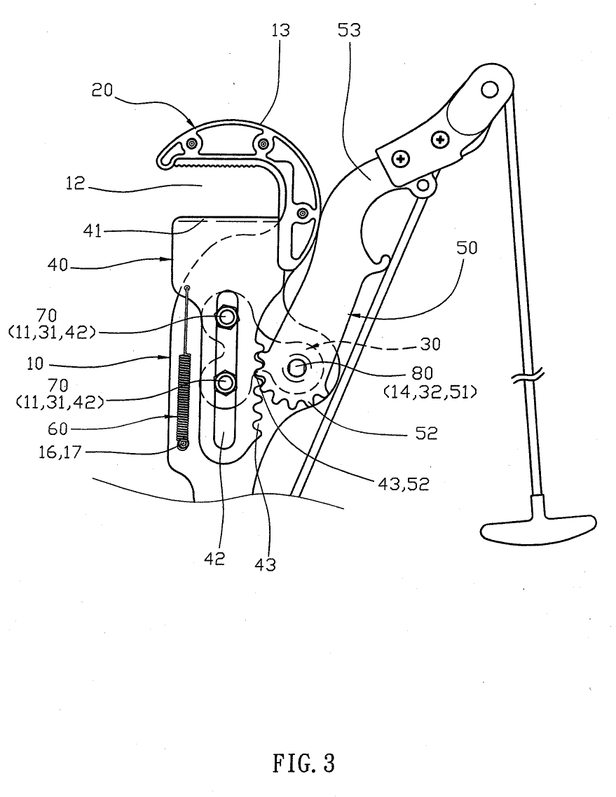

Referring to the drawings and initially to FIGS. 1-3, a pair of gardening shears in accordance with the preferred embodiment of the present invention comprise two support seats 10 spaced from each other, an anvil 20 mounted between the support seats 10, a slide 40 movably mounted between the support seats 10 and having a first end formed with a cutting blade 41 that is movable relative to the anvil 20, a rotation arm 50 pivotally mounted between the support seats 10 and connected to the slide 40 to move the slide 40 relative to the anvil 20 by rotation of the rotation arm 50, two support plates 30 located between the support seats 10 and rested on the slide 40 and the rotation arm 50 so that the slide 40 and the rotation arm 50 are located between the support plates 30, and a restoring spring 60 biased between the support seats 10 and the slide 40 to pull the cutting blade 41 of the slide 40 to space from the anvil 20.

Each of the support seats 10 has an upper end 13 formed with an opening 12 in which the cutting blade 41 of the slide 40 is movable, a middle portion formed with two spaced positioning holes 11, a through hole 14 and a fixing hole 16, and a lower end formed with a connecting portion 15 mounted on a handle 19. A receiving space 18 is defined between the support seats 10 to receive the anvil 20, the slide 40, the rotation arm 50, the restoring spring 60 and the support plates 30.

The anvil 20 is mounted between the upper ends 13 of the support seats 10 and located above the opening 12 of each of the support seats 10 and the cutting blade 41 of the slide 40.

The slide 40 has a second end formed with an elongated guide slot 42 and has a side formed with an elongated driven rack 43. Each of the guide slot 42 and the driven rack 43 of the slide 40 is extended in an axial direction of the slide 40. The guide slot 42 of the slide 40 is parallel with the driven rack 43. The first end of the slide 40 is formed with a fixing bore 44 located under the cutting blade 41.

The restoring spring 60 has a first end fixed in the fixing bore 44 of the slide 40, and the gardening shears further comprise a fixing member 17 extended through the fixing hole 16 of each of the support seats 10 and a second end of the restoring spring 60 to attach the second end of the restoring spring 60 to the support seats 10.

The gardening shears further comprise two guide members 70 each extended through a respective positioning hole 11 of each of the support seats 10 and the guide slot 42 of the slide 40 so that the guide slot 42 of the slide 40 is slidable on the guide members 70 to guide movement of the slide 40.

The rotation arm 50 has a first end pivotally mounted between the support seats 10 and formed with a drive gear portion 52 meshing with the driven rack 43 of the slide 40 and a second end formed with a drive handle 53. The first end of the rotation arm 50 is formed with a pivot hole 51, and the drive gear portion 52 of the rotation arm 50 has a substantially arc-shaped profile and is pivotable about the pivot hole 51. The drive gear portion 52 of the rotation arm 50 surrounds the pivot hole 51 of the rotation arm 50, and the pivot hole 51 of the rotation arm 50 is located at a central position of the drive gear portion 52 of the rotation arm 50.

The gardening shears further comprise a pivot member 80 extended through the through hole 14 of each of the support seats 10 and the pivot hole 51 of the rotation arm 50 so that the rotation arm 50 is pivotable about the pivot member 80 and the drive gear portion 52 of the rotation arm 50 is pivotable about the pivot member 80.

Each of the support plates 30 is formed with two spaced positioning bores 31 to allow passage of the guide members 70 and a through bore 32 to allow passage of the pivot member 80.

In operation, a plant to be cut is received into the opening 12 of each of the support seats 10 and located between the cutting blade 41 of the slide 40 and the anvil 20.

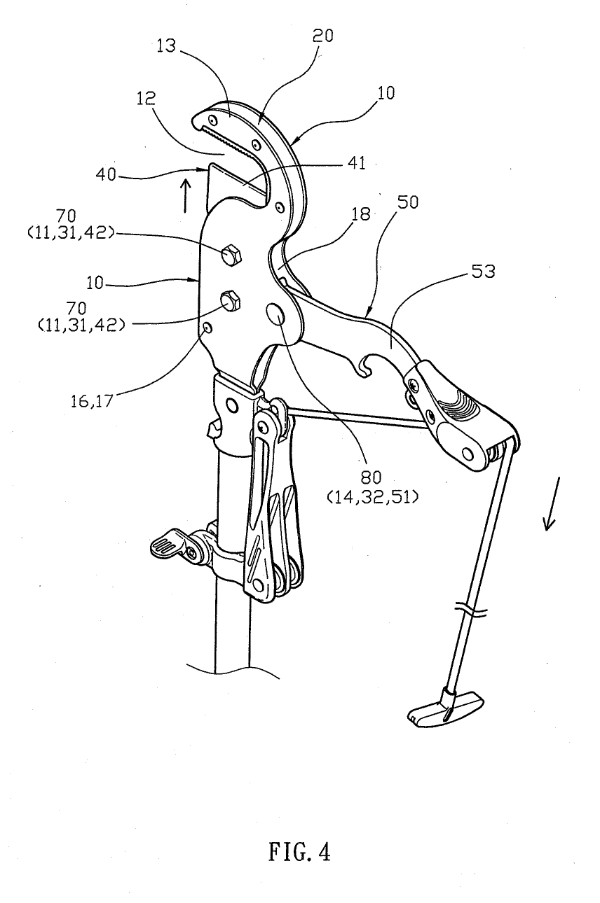

As shown in FIG. 4, the drive handle 53 of the rotation arm 50 is movable outwardly and downward relative to the support seats 10 to rotate the drive gear portion 52 of the rotation arm 50 about the pivot member 80 by a leverage action to move the driven rack 43 of the slide 40, so that the cutting blade 41 of the slide 40 is movable toward the anvil 20 by rotation of the rotation arm 50. At this time, the guide slot 42 of the slide 40 is slidable on the guide members 70 to guide movement of the slide 40.

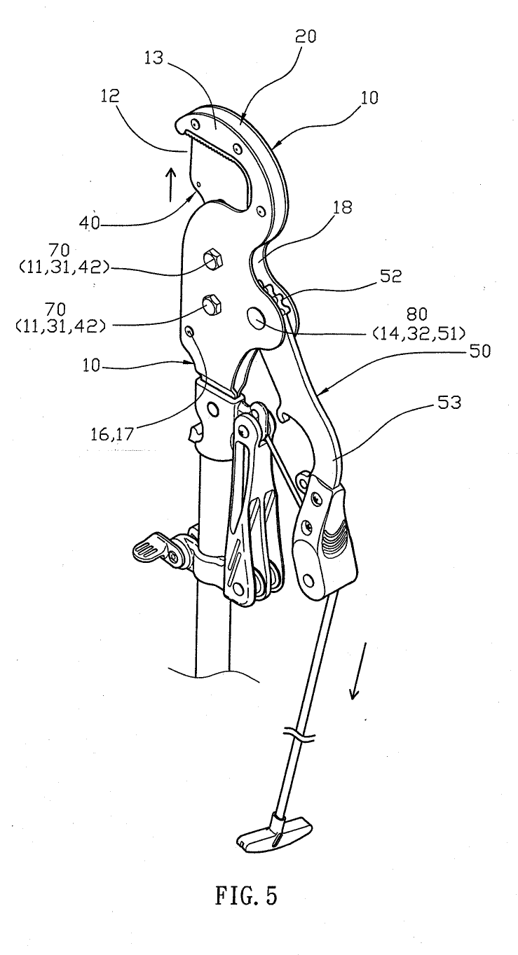

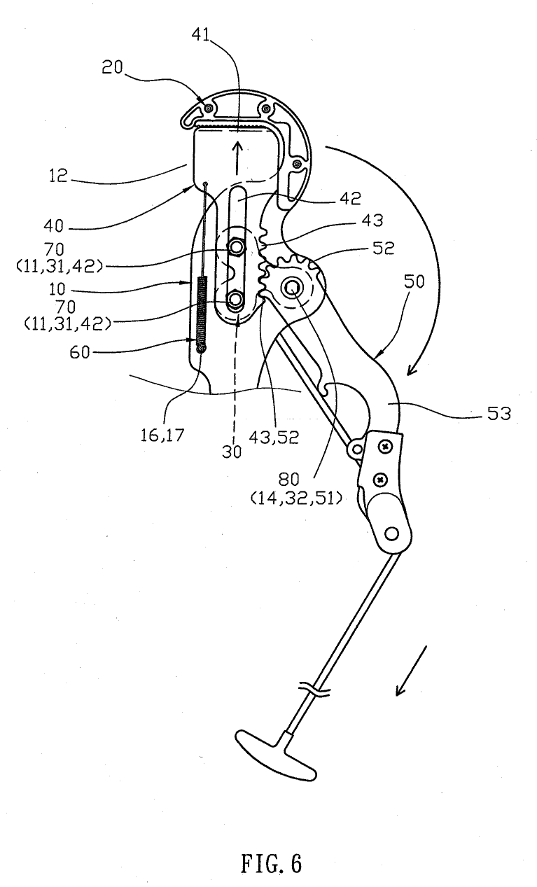

As shown in FIGS. 5 and 6, the cutting blade 41 of the slide 40 is movable to rest on the anvil 20 so as to cut the plant. After the force applied on the drive handle 53 of the rotation arm 50 is removed, the cutting blade 41 of the slide 40 is movable to space from the anvil 20 by the restoring force of the restoring spring 60.

As shown in FIGS. 1-6, the gardening shears are available for a pruning hook.

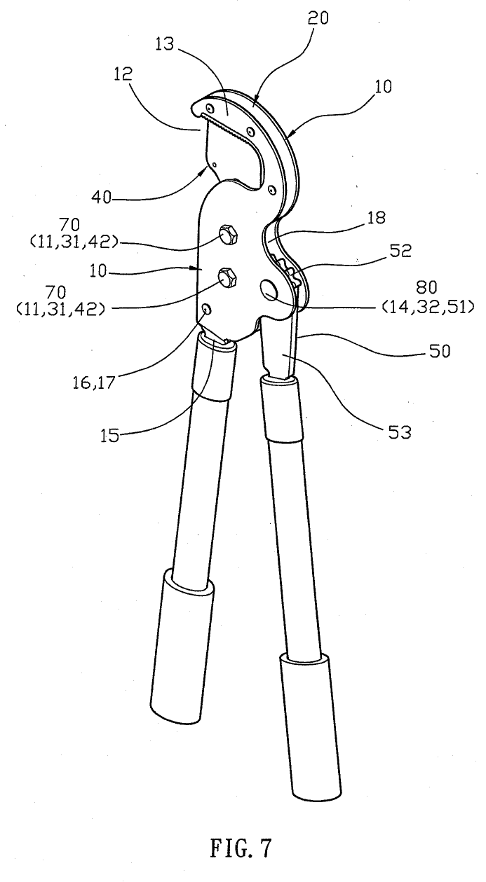

As shown in FIG. 7, the gardening shears are available for lopping shears.

Accordingly, the gardening shears comprise two support seats 10, an anvil 20, a slide 40, a rotation arm 50, and a restoring spring 60 so that the gardening shears have a simplified construction, thereby decreasing the costs of fabrication and assembly. In addition, the drive handle 53 of the rotation arm 50 drives the drive gear portion 52 of the rotation arm 50 by a leverage action to move the driven rack 43 of the slide 40, so that the rotation arm 50 produces a two-stage drive force on the slide 40 to drive the cutting blade 41 of the slide 40 to move toward the anvil 20 in an energy-saving manner, thereby greatly facilitating a user operating the gardening shears.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pair of gardening shears, comprising:
two support seats spaced from each other;
an anvil mounted between the support seats;
a slide movably mounted between the support seats and having an end portion formed with a cutting blade that is movable relative to the anvil;
a rotation arm pivotally mounted between the support seats and connected to the slide to move the slide relative to the anvil by rotation of the rotation arm relative to the support seats and the slide;
wherein the slide has a side formed with an elongated driven rack;
the rotation arm has an end portion formed with a drive gear portion pivotally mounted between the support seats and meshing with the driven rack of the slide.

2. The gardening shears in accordance with claim 1, wherein
each of the support seats has a middle portion formed with a through hole;
the end portion of the rotation arm is formed with a pivot hole;
the gardening shears further comprise a pivot member extended through the through hole of each of the support seats and the pivot hole of the rotation arm so that the rotation arm is pivotable about the pivot member and the drive gear portion of the rotation arm is pivotable about the pivot member.

3. The gardening shears in accordance with claim 2, wherein the drive gear portion of the rotation arm is pivotable about the pivot hole of the rotation arm.

4. The gardening shears in accordance with claim 2, wherein the drive gear portion of the rotation arm surrounds the pivot hole of the rotation arm.

5. The gardening shears in accordance with claim 2, wherein the drive gear portion of the rotation arm has a substantially arc-shaped profile.

6. The gardening shears in accordance with claim 5, wherein the pivot hole of the rotation arm is located at a central position of the drive gear portion of the rotation arm.

7. The gardening shears in accordance with claim 2, further comprising:
two support plates located between the support seats and rested on the rotation arm so that the rotation arm is located between the support plates;

8. The gardening shears in accordance with claim 7, wherein each of the support plates has a first end located between the support seats and a second end formed with a through bore to allow passage of the pivot member.
